(19) United States
(12) Patent Application Publication
(10) Pub. No.: US 2008/0229586 A1
(43) Pub. Date: Sep. 25, 2008

(54) Seafood Utensil

(76) Inventors: Richard C. Knepfle, Mason, OH (US); David Olmutz, Mason, OH (US); Candace Paul, Mason, OH (US); Gary Waters, Hamilton, OH (US)

Correspondence Address: FROST BROWN TODD, LLC, 2200 PNC CENTER, 201 E. FIFTH STREET, CINCINNATI, OH, 45202, US

(21) Appl. No.: 11/689,270

(22) Filed: Mar. 21, 2007

(51) Int. Cl. B26B 1/10

(52) U.S. Cl. 30/165

(57) ABSTRACT

A seafood utensil functioning as both a seafood fork and cutting tool, the seafood utensil including a grip portion operably configured for gripping between the thumb and forefinger of a diner, a first tine including a pivot operably configured to function as a fulcrum when cutting shellfish, and a second tine including an edge operably configured to cut through shellfish, the first tine and the second tine being in spaced apart relation.

### FIELD OF THE INVENTION

The present invention relates, in general, to dining utensils and, in particular, to dining utensils configured for cracking the shells of shellfish and removing the meat therefrom.

### BACKGROUND OF THE INVENTION

Sections of shellfish, such as Alaskan King crab legs, are often served in the shell, which must be broken or otherwise opened in order to remove the edible portion. Seafood pliers are often used by diners or restaurant patrons to crack the shellfish by compressing the shell. The resultant cracking is frequently accompanied by splattering liquid that may be embarrassing and may soil clothing. Thus, it is common for shellfish to be served with bibs to be worn by the eater. While the bib may protect the eater, it does not protect those in the vicinity of the eater and the bib may be unwelcome to those easily embarrassed. Typically, the use of a cracker-type device also requires the use of a second utensil in the form of a small seafood fork. Requiring two utensils may increase the costs of serving shellfish for restaurants that must provide and maintain both utensils. It would therefore be advantageous to provide a single utensil that may be used to both efficiently remove and eat meat from shellfish.

A number of integrated seafood utensils have been developed including a combination utensil described in U.S. Pat. No. 7,134,206 to Bach. The combination utensil is used for preparing and eating crustaceans and has an elongated handle portion having, at one end, a shell breaking tool and, at the other end, a seafood fork. However, the Bach utensil may make the eating experience for diners awkward as the utensil must be rotated 180 degrees when moving from cutting to eating, and vice versa. When dealing with particularly juicy seafood, such rotation may result in the fluid covered cutting end brushing against the diner's sleeve or arm while using the fork portion, and vice versa. It would therefore be advantageous to provide a single seafood utensil that allows a diner to enjoy both a cutting and a fork feature without having to rotate the utensil and without having to be concerned about soiling their clothing.

A shellfish eating tool is described in U.S. Pat. No. 7,125,329 to Mindes. The tool includes a first end and a second end, the first end including a knife-like protuberance spaced apart from a flattened protuberance. The first end is configured to cut shellfish, the knife-like protuberance being inserted into a shell and the flattened protuberance being used as a fulcrum in opening the shellfish. The second end includes a probe portion configured to extend into shellfish to extract meat therefrom. However, the Mindes tool, like the Bach utensil, requires a diner to rotate the tool 180 degrees between cutting and eating, and vice versa. As each end of the instrument becomes soiled by seafood juices, the diner may be reluctant to bring the soiled ends near their clothing and may opt, instead, to simply use a fork. The use of an additional utensil may result in more maintenance for the restaurant and less convenience for the consumer. A number of utensils, such as the shell seafood cracking and service device having a handle grip, described in U.S. Pat. No. 6,390,911, may expose a user's hand to sharp objects and undesirable seafood juices when in use.

As shown by the position of the grips, the Mindes tool is operated by grasping the handle with a portion of the user's hand above and below the tool. As many crustaceans are spiny, and because split shells often have sharp edges, such devices may expose a diner's hand to injury as the device is moved along the shellfish. Also, gripping a device in such a manner may cause the diner's hand to dip into butter sauce or juices commonly found in seafood. It would be advantageous to provide an instrument configured to help protect a user from sharp objects that may harm or irritate a diner's hand. Additionally, it would be advantageous to provide a utensil that allows a diner to substantially avoid contact with liquefied butter or seafood fluids.

A utensil for opening shellfish is disclosed in U.S. Pat. No. 7,121,939 to Quaglino. The knife includes an elongated handle, a blade attached to and extending longitudinally from an end of the handle, and a shell-slitting tine attached to the blade adjacent a top portion of the blade. However, the blade and the single tine configuration of the knife do not make the utensil suitable for use as a fork as well as a seafood opener. A user of the Quaglino utensil would be required to use an additional fork to extract meat from the seafood.

As discussed, requiring multiple utensils may be cumbersome and may increase the cost of maintenance for the restaurant. In addition, the utensil is provided with a standard knife grip that may not allow for precise dexterous movements helpful when shelling crustaceans.

A seafood knife is described in U.S. Pat. No. 4,172,306 to Hopkins. The knife includes a planar blade with an open ended slot extending linearly from a terminal end of the blade along the longitudinal axis of the blade for an inch or two. The slot symmetrically divides the blade into two identical sections. In use, one section of the knife is inserted into the interior of the crab leg, with the other section straddling the exterior of the shell. By lifting upward with the knife, the knife is rotated about its terminal end, and acts as a lever to break the shell. However, because a narrow and pointed edge is formed at the terminal end of the external fork by the linear slot, lifting of the utensil may cause the pointed edge to pierce the shell of the crab resulting in an interrupted movement in opening the shell. Piercing the shell in this manner may also damage the edible portions of the meat. In addition, the user must grip the utensil with a standard knife grip at the base that may make small dexterous movement with the knife difficult. Also, the configuration of the terminal ends of the fork are such that use of the knife to insert meat into the diner's mouth may be dangerous and impractical. Utensils having similar features are disclosed in U.S. Pat. No. 5,613,904 to LaSalle and U.S. Pat. No. 5,586,931 to Williams, where the cutting projections are not configured for use as fork tines and may be injurious if inserted into the mouth. It would therefore be advantageous to provide a seafood utensil facilitating a substantially uniform cutting motion, operably configured to make dexterous cutting motions, and safe to use as both a seafood cutter and a seafood fork.

Another type of utensil for removing meat from shells is described in U.S. Pat. No. 4,200,961 to Mueller. The Mueller patent discloses a lobster fork having a plurality of generally parallel tines, and an outermost claw tine. The claw tine is shorter than and angled away from the other tines. To break open a shell, an edge of the shell is inserted between the claw tine and the parallel tines, and the utensil is used as a lever in a manner similar to the Hopkins patent. However, because the claw is shorter than and diverges from the parallel tines, the fork may neither properly grip nor provide proper leverage for narrow, elongated crab leg shells. The diverging claw tine may also tend to project into the edible portions of the crab leg.

It would be advantageous to provide a utensil for both removing the shells of seafood and extracting the meat therefrom such that only a single utensil is needed to accomplish both functions without rotation. It would also be advantageous to provide a utensil for removing the shells of crustaceans that avoids a substantial amount of splattering and potential damage to the meat. It would be advantageous to provide a utensil that may be constructed and maintained cost effectively, and it would be advantageous to provide a utensil that is configured for opening and eating shellfish without exposing a user's hands to sharp edges and tines and to unsavory fluids.

### BRIEF DESCRIPTION OF THE DRAWING

The accompanying drawings incorporated in and forming a part of the specification illustrate several aspects of the present invention, and, together with the description, serve to explain the principles of the invention; it being understood, however, that this invention is not limited to the precise arrangements shown. In the drawings, like reference numerals refer to like elements in the several views. In the drawings:

FIG. 1 is a perspective view of one version of a utensil for cutting and eating crustaceans.

FIG. 2 is a side view of the utensil for cutting and eating crustaceans illustrated in FIG. 1.

FIG. 3 is an environmental view of the utensil of FIG. 1 shown inserted into a crustacean leg prior to cutting.

FIG. 4 is an environmental view of the crustacean leg of FIG. 3 shown with the utensil of FIG. 1 cutting through the shell.

FIG. 5 is an environmental view of the crustacean leg of FIG. 3 shown with the utensil of FIG. 1 removing meat from the shell.

FIG. 6 is a perspective view of an alternate version of a utensil for cutting and eating crustaceans.

FIG. 7 is a perspective view of an alternate version of a utensil for cutting and eating crustaceans.

FIG. 8 is a perspective view of an alternate version of a utensil for cutting and eating crustaceans.

### DETAILED DESCRIPTION OF THE INVENTION

Provided is a utensil for opening seafood and for removing the meat therefrom. Versions of the utensil combine a cutting element and fork element at a single end of the utensil to eliminate the need for additional dining utensils. Also, combining the cutting element and the fork element at a single end eliminates a diner having to rotate the utensil 180 degrees, where the constant rotation of a utensil may be inefficient and may dirty the diner's garments. The seafood fork may be a unitary construction to reduce the maintenance associated with a single diner using multiple utensils or with utensils having numerous parts that may clog, break, or require hand washing. In this manner, versions of the seafood fork disclosed herein may reduce restaurant overhead and improve the diner's gastronomical experience.

In addition to other benefits, provided are versions of a seafood utensil configured for efficiently opening and eating seafood that protect the user from sharp edges frequently found on seafood and from maculating fluids such as butter sauce. Providing such a seafood fork, and using the seafood fork in accordance with methods described herein, may be particularly well suited for business people wearing suit jackets and other expensive clothing. Making eating seafood a cleaner and more efficient process may assist servers and restaurants in selling more of these high priced menu items.

Seafood utensils or forks described herein may also be configured such that they include marketing logos and trademarks that also function as texturing for grip elements. Portions of the utensils described herein include a flattened grip or pad portion that may be provided with markings that highlight a business trademark, slogan, or logo that also function as texture for gripping the utensil. As will be discussed in greater detail, versions of the seafood utensil described herein may diminish the overhead and maintenance of restaurants, increase the sales of high priced seafood items, make dining on crustaceans more pleasurable and efficient, make seafood more appealing to well-dressed individuals, and providing a marketing opportunity for businesses.

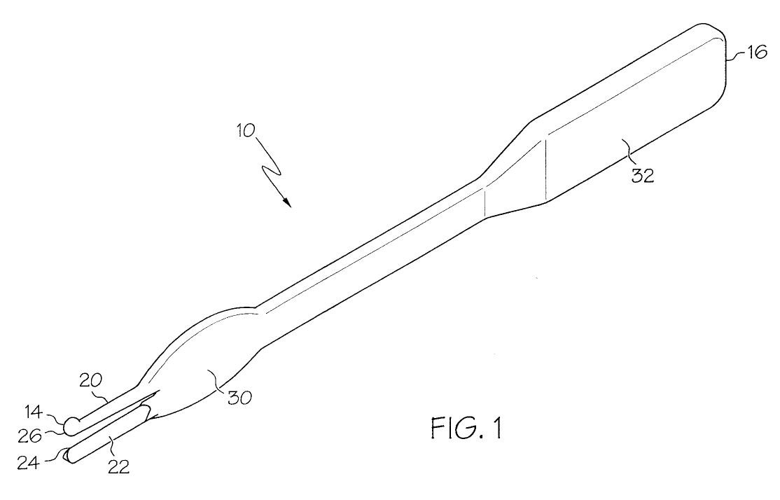

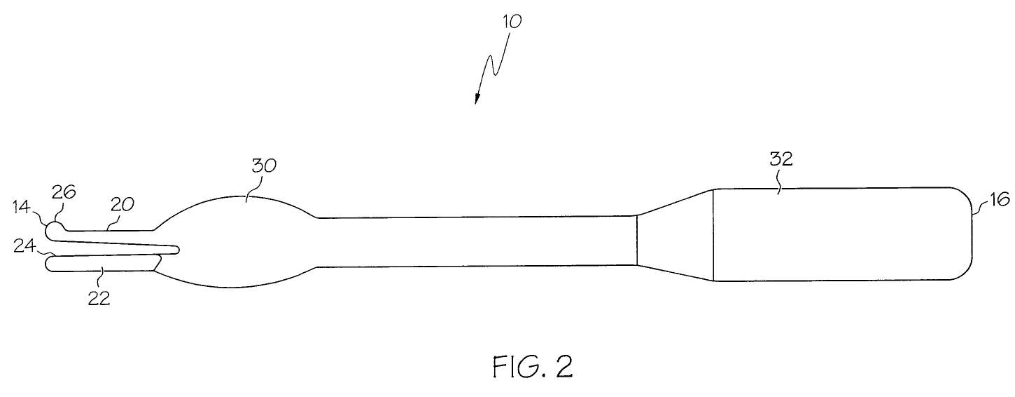

FIGS. 1-2 illustrate one version of a utensil 10 for opening the shells of and extracting meat from shellfish and/or crustaceans. The utensil 10 includes a first end 14 and a second end 16. The first end 14 may include a first tine 20 and a second tine 22, where the second tine 22 is angled away from and is in a spaced relation to first tine 20. The second tine 22 may have an edge 24 which may have a generally knife-like or cutting configuration. The first tine 20 may include a pivot 26 located at about the terminal end thereof, which may generally face the second tine 22. With this configuration, the second tine 22 may be extended underneath the shell of a shellfish and/or crustacean and the first time may remain external to the shell. As will be discussed herein, the flat portion may function as a fulcrum upon which the utensil 10 may pivot or torque in a generally upward direction to slice through the shell. The utensil 10 may be a unitary construction configured for easy washing and maintenance and may be constructed from a substantially corrosion resistant material such as stainless steel or plastic.

The first tine 20 may project from the distal end of a cutting grip portion 30 of the utensil 10. The first tine 20 may be a projection, a protuberance, a prong, or any other suitable element. The first tine 20 may be linear and project at an angle in a generally upward direction from the cutting grip portion 30. Any suitable angle of projection is contemplated and may, for example, be determined by the type of seafood for which the utensil 10 is adapted. In the illustrated version, the first tine 20 is substantially rigid such that pressure may be placed against the pivot 26 to drive the second tine 22 through the shell of a crustacean.

The pivot 26 may be a substantially flat portion of the first tine 20 located at about the distal end thereof that may be pressed against the outer shell surface of a crustacean during use. The pivot 26 may be flat or otherwise have sufficient surface area or bluntness such that pressure applied to the shell when torquing the utensil 10 does not readily puncture the shell. In this manner, the user may apply an efficient and consistent cutting motion to the seafood without puncturing the shell and possibly damaging the delicate meat.

The first tine 20 and the pivot 26 may be configured, as illustrated, such that the first tine 20 functions both as a fulcrum in cutting through a crustacean shell and as a fork tine. For example, the pivot 26 may be tapered and/or have a terminal end similar to that of a traditional fork such that the pivot 26 does not substantially interrupt the diner's use of the utensil 10 as a fork as well as a cutter. In this manner, the diner may use a single utensil 10 to both cut and eat shellfish. By incorporating both a fork and a cutting element into the first end 14 of the utensil 10, the diner may enjoy both features without having to rotate the utensil 180 degrees, as is necessary in utensils having a cutting element at one end and a fork element at the other end.

The second tine 22 may be configured to cut, break, and/or otherwise open the shell of the shellfish, crustacean, or other food. The tines 20, 22 may be any suitable length, such as three centimeters in length, extending away from the cutting grip portion 30, however, other dimensions may be utilized as desired. It will be appreciated that the lengths of the tines 20, 22 may be identical or dissimilar. Similarly, the tines 20, 22 may be in different spaced relationships such that they will facilitate different uses for different types, and/or thicknesses of shellfish and/or crustacean shells, and the like. The spaced apart relationship of the tines 20, 22 and angles of configuration may, as illustrated, be selected to function both as a cutting instrument as well as a seafood fork. The tines may be adjustable, such as by providing a flexible or semi-rigid material, such that the utensil 10 may be configured for a plurality of applications.

Still referring to FIGS. 1-2, the second tine 22 may include an edge 24 that is sharpened or otherwise configured to cut the shell of a crustacean. As the shells of crustaceans are generally less resistant to cutting from the inside out rather than vice versa, a number of surface effects or edges 24 may be provided on the second tine 22 such as serrations, edging, texture, or the like. The second tine may project from the utensil 10 generally along or parallel to the longitudinal axis thereof or may project at an angle therefrom. It will be appreciated that the second tine 22 may be provided with a blunt terminal end such that the second tine 22 may also be used as a fork tine without causing injury to a diner's mouth. In one version the sharpness of the second tine 22 is sufficient to cut the shell of a crustacean from the inside out but is not sharp enough to cut or otherwise harm a diner. In such a manner the pivot 26 of the first tine 20 and the edge 24 of the second tine 22 may function at a first time as a seafood cutter and the terminal ends of the tines 20, 22 may function as a seafood fork at a second time.

Still referring to FIG. 1, the tines 20, 22 may be connected at their proximal ends to the cutting grip portion 30. As illustrated, the cutting grip portion 30 may be a circular or ovular portion of the utensil 10 operably configured to be gripped by the thumb and forefinger of a diner such that no portion of the diner's hand need extend below the utensil 10 when used to cut shellfish. The cutting grip portion may be a smooth, textured, or knurled portion that is configured to be grasped firmly and easily between the thumb and forefinger. The cutting grip portion 30 may include indentations, or the like, which may be configured to receive fingers of a user such that torque and/or other forces may be applied to the utensil 10, and consequently transferred to the shell of the shellfish and or/crustacean to aid in the opening of shellfish. The cutting grip portion 30 may be relatively thin relative to the tines 20, 22 such that the diner may exercise a great deal of control over the utensil 10 due to the proximity of their digits. Configurations of the cutting grip portion 30 may include a thumb surface (not shown) on one side of the utensil 10 configured to accept a thumb in the cutting position and a forefinger surface (not shown) to accept a forefinger in the cutting position. The substantially round, circular, or ovular shape of the cutting grip portion 30 may be well suited to advertise a manufacturer's, restaurant's, or distributor's logo prominently.

Still referring to FIG. 1, the proximal end of the cutting grip portion 30 may be connected to the distal end of a fork handle portion 32. The fork handle portion 32 may be an elongate portion extending along the longitudinal axis of the utensil 10. The fork handle portion 32 may, in an alternate version, be coupled or integrally formed with the cutting grip portion 30 at any suitable angle where, for example, angling the fork handle portion 32 away from the seafood may help protect the user's hands and clothes. The fork handle portion may resemble, for example, a traditional fork handle and may be operably configured for use in removing the meat from the opened shell of a crustacean. The fork handle portion 32 may be partially curved or ergonomically configured to support the palm of the diner while using the cutting grip portion 30 and to provide a stable grip when the diner is using the utensil 10 as a fork in the traditional manner. When used to cut shells in this manner, as will be illustrated in greater detail, the diner may grip the utensil near the first end 14 at the cutting grip portion 30 for control and dexterity with the hand removed from sharp seafood edges and maculating fluids. After efficiently cutting through the seafood shell with the cutting grip portion, the user may simply switch their grip back to the fork handle portion 32 to remove meat from the cut shell. In this manner, a single utensil 10 may be used to cut and eat shellfish without exposing the diner to sharp edges and unsavory liquids and without requiring the user to rotate the utensil 180 degrees to use both the cutting and meat extraction functions.

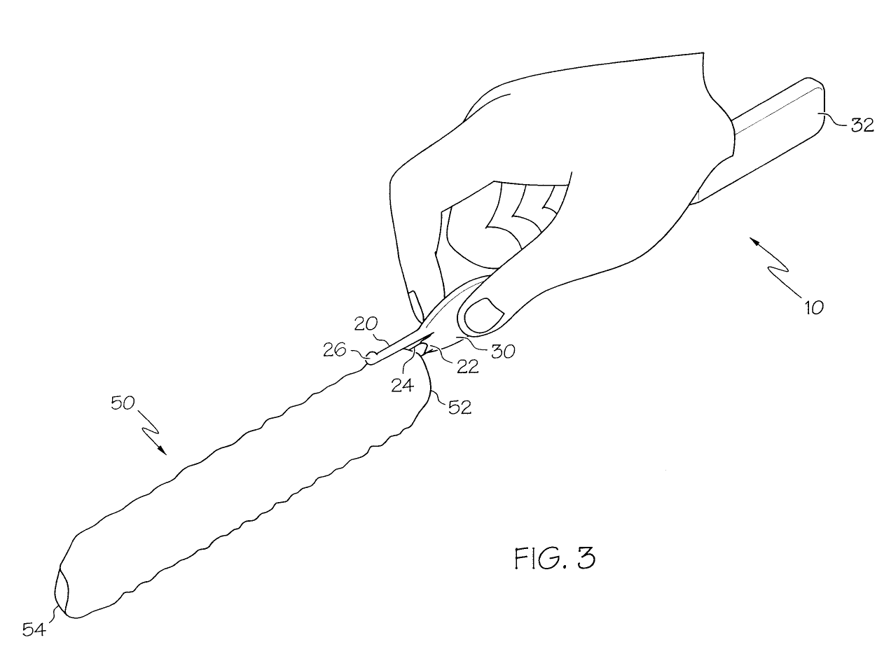

Referring to FIG. 3, shown is one version of a step for inserting the utensil 10 into a shellfish portion 50, such as a crab leg, to cut the shellfish portion. The shellfish portion 50 has a proximal end 52 and a distal end 54, where the second tine 22 may be inserted into the shellfish portion at the proximal end 52 and held adjacent to the inner surface of the shellfish portion 50. In one version, the utensil 10 is inserted into the shellfish portion 50 until the intersection of the first tine 20 and the second tine 22 abuts the shell. As illustrated, during the insertion step, the diner may be gripping the cutting grip portion 30 located adjacent the tines 20, 22 to assist the user in dexterously inserting the utensil.

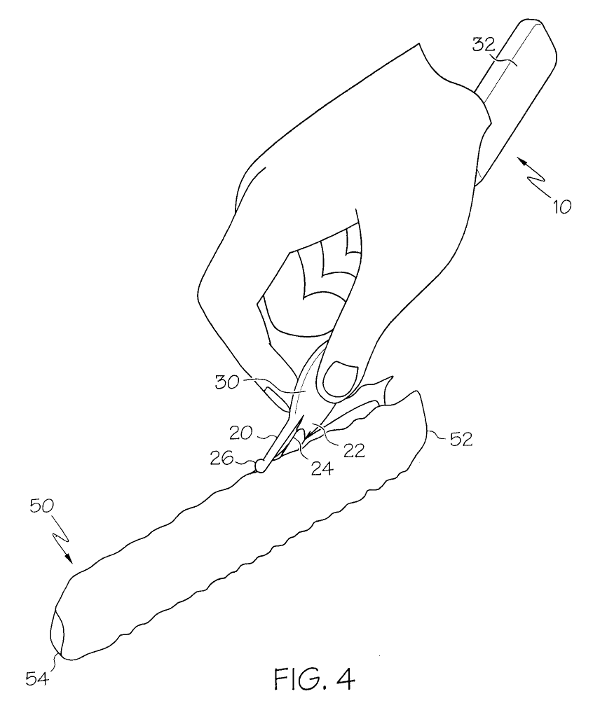

Following the insertion step, the diner may torque the utensil 10 in a generally upward direction about the pivot 26 as illustrated in FIG. 4, such that the shell is cut. The configuration of the pivot 26 may provide sufficient surface area to allow the utensil 10 to be rotated thereabout without causing the pivot 26 to puncture the shell. As the utensil 10 is rotated about the pivot 26, the edge 24 of the second tine 22 is drawn into and cuts the shell. After completing a cut, the diner may simply reinsert the utensil 10 into an uncut region of the shellfish portion, as illustrated in FIG. 3, before again rotating the utensil in accordance with FIG. 4. By continuing along in this manner from the proximal end 52 to the distal end 54 of the shellfish portion, the shell may be split in an efficient and clean manner that is substantially uninterrupted.

Still referring to FIGS. 3-4, as illustrated, by grasping the cutting grip member 30 between the thumb and forefinger, the diner may efficiently cut through crab legs, or any other suitable food, without a portion of the hand projecting below the utensil 10. In this manner, the diner may avoid sharp edges commonly associated with seafood and may also avoid maculating fluids, such as liquefied butter sauce, commonly used when dining on seafood. The device and method illustrated in FIGS. 3-4 may provide an efficient seafood dining system and method that makes dining on seafood a cleaner and more enjoyable process.

In one version, the shellfish portion 50 may be efficiently opened by providing two opposite throughall longitudinal cuts with the utensil 10. The cuts may substantially bisect the shellfish portion such that the shell may simply be split in half to expose the meat for removal. In one version, the two longitudinal cuts are made along the softer side portions of, for example, crab legs, where this less rigid area of the shell may be opened more quickly.

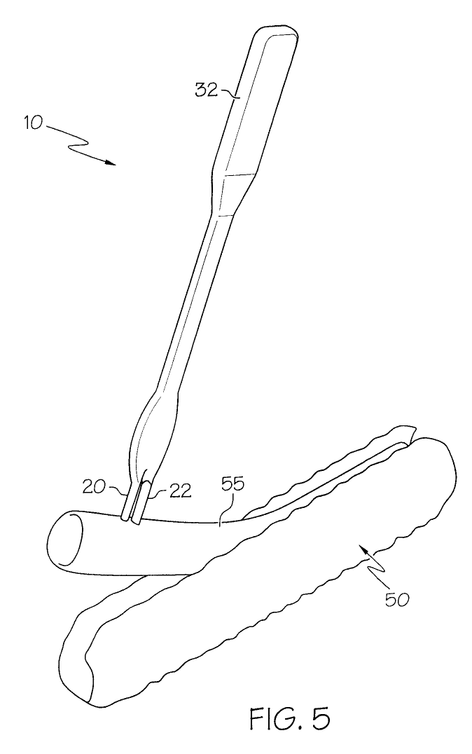

Referring to FIG. 5, after the shellfish portion 50 has been cut one or a plurality of times, the utensil 10 may be used to extract meat 55 from the cut shell. As illustrated, to extract the meat 55, the diner may grasp the fork handle portion 32 and insert the tines 20, 22 into the meat 55. In this manner, the tines 20, 22 may serve a dual purpose of cutting and forking shellfish without requiring rotation of the utensil 10 or a plurality of additional utensils. Although the meat of shellfish is highly desirable, it is often a great deal of work for a small reward. The utensil 10 may allow a diner to quickly transition from cutting to eating, and vice versa, such that the diner no longer needs to spend the majority of the meal trying to get at this savory meat. Providing the version of the utensil 10 having a unitary construction may appeal to restaurants desiring to keep maintenance and overhead costs low. Business people, and other consumers, concerned about their clothing may appreciate being able to enjoy seafood without having to be concerned about staining their garments.

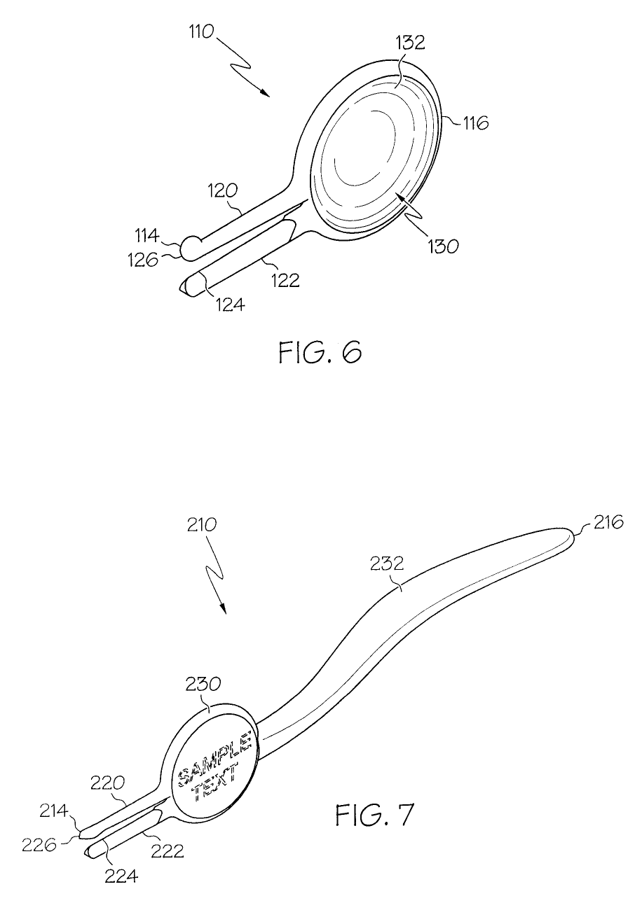

Referring to FIG. 6, illustrated is an alternate version of a utensil 110 for opening the shells of and extracting meat from shellfish and/or crustaceans. The utensil 110 includes a first end 114 and a second end 116. The first end 114 may include a first tine 120 and a second tine 122, where the second tine 122 is angled away from and is in a spaced relation to first tine 120. The second tine 122 may have an edge 124 which may have a generally knife-like or cutting configuration. The first tine 120 may include a pivot 126 located at about the terminal end thereof, which may generally face the second tine 122.

The second tine 122 may be configured to cut, break, and/or otherwise open the shell of the shellfish and/or crustacean. The tines 120, 122 may be any suitable length, such as three centimeters in length extending away from a grip portion 130, however, other dimensions may be utilized as desired. It will be appreciated that the lengths of the tines 120, 122 may be identical or dissimilar. Similarly, the tines 120, 122 may be in different spaced relationships such that they will facilitate different uses for different types, and/or thicknesses of shellfish and/or crustacean shells, and the like. The spaced apart relationship of the tines 120, 122 and angles of configuration may, as illustrated, be selected to function both as a cutting instrument as well as a seafood fork.

Still referring to FIG. 6, the tines 120, 122 may be connected at their proximal ends to the grip portion 130. As illustrated, the grip portion 130 may be a substantially curvilinear portion of the utensil 110 having at least one treaded portion 132 and a concave surface on both sides thereof to facilitate gripping. The grip portion 130 is operably configured to be gripped by the thumb and forefinger of a diner such that no portion of the diner's hand need extend below the utensil 110 when used to cut shellfish. The grip portion 130 may include indentations, or the like, which may be configured to receive fingers of a user such that torque and/or other forces may be applied to the utensil 110, and consequently transferred to the shell of the shellfish and or/crustacean to aid in the opening of shellfish. Configurations of the grip portion 130 may include a thumb surface (not shown) on one side of the utensil 110 configured to accept a thumb in the cutting position and a forefinger surface (not shown) to accept a forefinger in the cutting position. The substantially round, circular, or ovular shape of the grip portion 130 may be well suited to advertise a manufacturer's, restaurant's, or distributor's logo prominently.

As illustrated, the utensil 110 of FIG. 6 may include only a grip portion 130 that functions as both the cutting grip and the grip for using the tines 20, 22 as a fork. In the illustrated version, the diner may maintain their grasp of the grip portion 130, between the thumb and forefinger, to both cut the shells and remove the meat of crustaceans. The utensil 110 may, for example, be a less formal version of the seafood utensil that may appeal to those who are looking to efficiently open a great deal of seafood quickly.

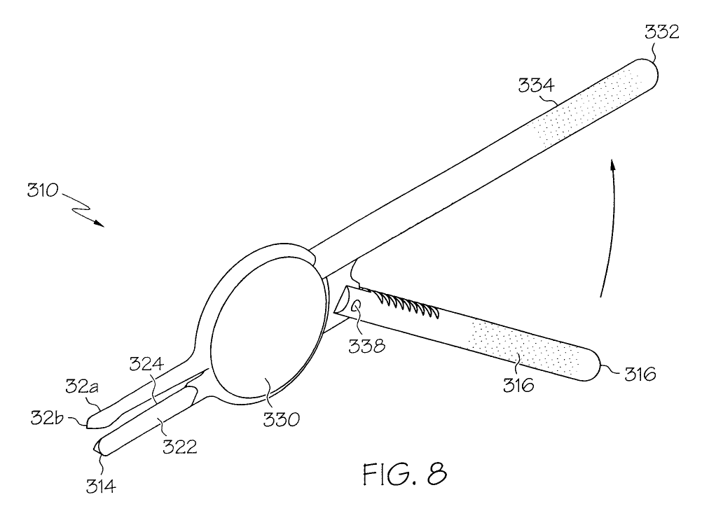

Referring to FIG. 7, disclosed is an alternate version of a utensil 210 for opening the shells of and extracting meat from shellfish and/or crustaceans. The utensil 210 includes a first end 214 and a second end 216. The first end 214 may include a first tine 220 and a second tine 222, where the second tine 222 is angled away from and is in a spaced relation to first tine 220. The second tine 222 may have an edge 224 which may have a generally knife-like or cutting configuration. The first tine 220 may include a pivot 226 located at about the terminal end thereof, which may generally face the second tine 222.

The second tine 222 may be configured to cut, break, and/or otherwise open the shell of the shellfish and/or crustacean. The tines 220, 222 may be any suitable length, such as three centimeters in length extending away from a grip portion 230, however, other dimensions may be utilized as desired. It will be appreciated that the lengths of the tines 220, 222 may be identical or dissimilar. Similarly, the tines 220, 222 may be in different spaced relationships such that they will facilitate different uses for different types, and/or thicknesses of shellfish and/or crustacean shells, and the like. The spaced apart relationship of the tines 220, 222 and angles of configuration may, as illustrated, be selected to function both as a cutting instrument as well as a seafood fork.

The tines 220, 222 may be connected at their proximal ends to the cutting grip portion 230. As illustrated, the cutting grip portion 30 may be a circular or ovular portion of the utensil 210 operably configured to be gripped by the thumb and forefinger of a diner such that no portion of the diner's hand need extend below the utensil 10 when used to cut shellfish. The cutting grip portion 230 may include lettering that is engraved or projects from the utensil 210 to provide both product advertising and a texture for gripping the utensil 210. Configurations of the cutting grip portion 230 may include a thumb surface (not shown) on one side of the utensil 210 configured to accept a thumb in the cutting position and a forefinger surface (not shown) to accept a forefinger in the cutting position. The substantially round, circular, or ovular shape of the cutting grip portion 230 may be well suited to advertise a manufacturer's, restaurant's, or distributor's logo prominently.

Still referring to FIG. 7, the proximal end of the cutting grip portion 230 may be connected to the distal end of a fork handle portion 232. The fork handle portion 232 may be an elongate portion extending along the longitudinal axis of the utensil 10 having a curvature configured to mold substantially to the shape of a human palm. For example, the fork handle portion 232 may be partially curved or ergonomically configured to support the palm of the diner while using the cutting grip portion 230 and to provide a stable grip when the diner is using the utensil 210 as a fork.

Referring to FIG. 8, disclosed is an alternate version of a utensil 310 for opening the shells of and extracting meat from shellfish and/or crustaceans. The utensil 310 includes a first end 314 and a second end 316. The first end 314 may include a first tine 320 and a second tine 322, where the second tine 322 is angled away from and is in a spaced relation to first tine 320. The second tine 322 may have an edge 324 which may have a generally knife-like or cutting configuration. The first tine 320 may include a pivot 326 located at about the terminal end thereof, which may generally face the second tine 322.

The tines 320, 322 may be connected at their proximal ends to a cutting grip portion 330. As illustrated, the cutting grip portion 330 may be a circular or ovular portion of the utensil 310. The proximal end of the cutting grip portion 330 may be connected to the distal end of a set of seafood pliers 332. The seafood pliers may include a first arm 334 moveable relative to a second arm 336 about a pivot 338 as is commonly known in the art. In one version, the first arm 334 is fused to the cutting grip portion 330 such that the first arm 334 may be held static as the second arm 336 is rotated about the pivot 338 to crack shellfish held therebetween. Providing a combination seafood fork and seafood pliers may allow a user to cut more delicate regions of shellfish with the tines 320, 322 and more unyielding shellfish portions with the seafood pliers 332.

Numerous benefits have been described which result from employing concepts of the invention. The foregoing description of one or more versions of the invention has been presented for purposes of illustration and description. It is not intended to be exhaustive or to limit the invention to the precise form disclosed. Obvious modifications or variations are possible in light of the above teachings. The one or more versions were chosen and described in order to best illustrate principles of the invention and its practical application to thereby enable one of ordinary skill in the art to utilize the invention in various versions and with various modifications as are suited to the particular use contemplated. It is intended that the scope of the invention be defined by the claims appended hereto.

What is claimed is:

1. A seafood utensil comprising:
a. a grip portion, the grip portion having a first end and a second end, wherein the first end of the grip portion is coupled with the second end of the handle member, wherein the grip portion is operably configured for gripping between the thumb and forefinger of a diner;
b. a first tine, the first tine having a first end and a second end, wherein the first end of the first tine is coupled with the grip portion and the second end is a terminal end, wherein the first tine includes a pivot operably configured to function as a fulcrum when cutting shellfish;
c. a second tine, the second tine having a first end and a second end, wherein the second end is a terminal end, wherein the second tine includes an edge operably configured to cut through shellfish, the first tine and the second tine being in spaced apart relation.

2. The seafood utensil of claim 1, further comprising a handle member, the handle member having a first end and a second end, wherein the first end of the handle member is a free end, wherein the handle member is operably configured for gripping while extracting the meat from shellfish.

3. The seafood utensil of claim 2, wherein the first tine and the second tine project at an angle distally from an intersection at about the grip portion.

4. The seafood utensil of claim 2, wherein the pivot of the first tine is positioned at about the terminal end of the first tine.

5. The seafood utensil of claim 4, wherein the pivot is tapered.

6. The seafood utensil of claim 2, wherein the grip portion includes texture.

7. The seafood utensil of claim 6, wherein the texture is a logo.

8. The seafood utensil of claim 2, wherein the grip portion includes a portion configured to receive a thumb and a portion configured to receive a forefinger.

9. The seafood utensil of claim 2, wherein the utensil is a unitary construction.

10. A method for shelling and eating crustaceans comprising the steps of:
a. providing a seafood utensil, the seafood utensil comprising;
i. a grip portion, the grip portion having a first end and a second end, wherein the grip portion is operably configured for gripping between the thumb and forefinger of a diner;
ii. a first tine, the first tine having a first end and a second end, wherein the first end of the first tine is coupled with the grip portion and the second end is a terminal end, wherein the first tine includes a pivot operably configured to function as a fulcrum when cutting shellfish;
iii. a second tine, the second tine having a first end and a second end, wherein the second end is a terminal end, wherein the second tine includes an edge operably configured to cut through shellfish, the first tine and the second tine being in spaced apart relation;
b. gripping the grip portion between the thumb and forefinger;
c. inserting the second tine into a shellfish portion;
d. lifting in a generally upward direction with the thumb and forefinger such that the seafood utensil rotates about the pivot of the first tine;
e. cutting the shellfish with the edge of the second tine; and
f. extracting meat from the shellfish portion with the first and second tine.

11. The method of claim 10, wherein the seafood utensil comprises a handle member connected at an angle to the cutting portion, the handle member having a first end and a second end coupled with the cutting portion, wherein the first end of the handle member is a free end, wherein the handle member is operably configured for gripping while extracting the meat from shellfish.

12. The method of claim 11, wherein the step of cutting the shellfish portion comprises rotating the seafood utensil a plurality of times about the pivot along the length of the shellfish portion.

13. The method of claim 12, wherein the step of cutting the shellfish portion comprises providing a first longitudinal cut and a second longitudinal cut, wherein the first longitudinal cut is substantially opposite the second longitudinal cut.

14. The method of claim 11, wherein the step of extracting meat from the shellfish portion comprises gripping the handle member and extracting the meat from the shellfish with the first tine and the second tine.

15. The method of claim 14, wherein the step of extracting meat from the shellfish portion comprises alternating the grip from the grip portion to the handle member.

16. The method of claim 11, wherein the seafood utensil is a unitary construction.

17. The method of claim 11, further comprising the step of providing the seafood utensil with texture.

18. The method of claim 11, wherein the step of providing the seafood utensil with texture comprises providing a textured logo on the grip portion.

19. The method of claim 11, wherein a set of seafood pliers is associated with the grip portion.

20. A method for shelling and eating crustaceans comprising the steps of:
a. providing a seafood utensil with a unitary construction, the seafood utensil comprising;
i. a handle member, the handle member having a first end and a second end, wherein the first end of the handle member is a free end, wherein the handle member is operably configured for gripping while extracting the meat from shellfish;
ii. a grip portion, the grip portion having a first end and a second end, wherein the first end of the grip portion is coupled with the second end of the handle member, wherein the grip portion includes a thumb-shaped portion operably configured for gripping with the thumb and a forefinger-shaped portion operably configured for gripping with the forefinger of a diner, wherein the grip portion is textured and is provided with a logo;
iii. a first tine, the first tine having a first end and a second end, wherein the first end of the first tine is coupled with the grip portion and the second end is a blunted terminal end, wherein the first tine includes a pivot operably configured to function as a fulcrum when cutting shellfish, the pivot having a surface area configured such that the pivot does not puncture shellfish during use;
iv. a second tine, the second tine having a first end and a second end, wherein the second end is a terminal end, wherein the second tine includes a sharpened edge operably configured to cut through shellfish, the first tine and the second tine being in spaced apart relation and projection distally at an angle from an intersection located at about the grip portion;
b. gripping the grip portion between the thumb and forefinger in the thumb-shaped portion and the forefinger-shaped portion;
c. inserting the second tine into a shellfish portion with the first tine external to the shellfish portion;
d. lifting in a generally upward direction with the thumb and forefinger such that the seafood utensil rotates about the pivot of the first tine;
e. cutting the shellfish with the edge of the second tine;
f. alternating the grip from the grip portion to the handle portion; and
g. extracting meat from the shellfish portion with the first and second tine.
